(19) United States
(12) Patent Application Publication
(10) Pub. No.: US 2005/0160861 A1
(43) Pub. Date: Jul. 28, 2005

(54) Gear shift assembly

(75) Inventors: Klaus Plietker, Diepholz (DE); Torsten Mattfeld, Bremen (DE)

Correspondence Address: NORRIS, MCLAUGHLIN & MARCUS, 875 THIRD AVE, 18TH FLOOR, NEW YORK, NY, 10022, US

(73) Assignee: ZF Lemforder Metallwaren AG, Lemforde (DE)

(21) Appl. No.: 10/976,250

(22) Filed: Oct. 28, 2004

(30) Foreign Application Priority Data
Nov. 13, 2003 (DE) DE 103 53 240.0

(51) Int. Cl. G05G 9/00

(52) U.S. Cl. 74/473.15

(57) ABSTRACT

The invention is directed to a gear shift assembly for a gear box of an automobile, with a gear shift pattern that includes at least two gear shift gates arranged approximately in the longitudinal direction of the automobile and at least one gear selection gate arranged perpendicular to the gear shift gates, with a gear shift lever supported for pivoting about two pivot axles, wherein a first pivot axle represents a gear shift axle and another pivot axle represents a gear selection axle, and wherein by pivoting the gear shift lever, a gear shift motion in the direction of a gear shift gate and a gear selection motion in the direction of the gear selection gate can be performed, wherein the gear selection motion and gear shift motion are decoupled from each other, and a crosspiece (8) with a gear shift lever (2) secured to the crosspiece with an offset from the gear shift axle is supported in a housing (9) for pivoting about the gear shift axle. The pivoting motion in the direction of the gear shift motion causes the crosspiece (8) to follow the gear shift lever (2), thereby operating the gear shift cable pull that is secured to a lower free end of the crosspiece (8).

### BACKGROUND OF THE INVENTION

1) Field of the Invention

The present invention is directed to a gear shift assembly for a gear box according to the features of the preamble of independent claim 1.

2) Description of the Related Art

Gear shift assemblies of this type are known in the art. DE 197 39 632 A1 discloses a gear shift assembly for manually operating a gear shift mechanism and includes a gear shift lever supported in a ball joint. The gear shift lever is connected with two additional actuating elements mounted in two additional ball joints, thereby forming two mutually decoupled pivot axles for operating gear shift components, such as for example cable pulls or gear change rods. One weak point of this type of ball joint is the risk that the ball disengages from the bearing shell of the ball joint. This problem is solved in DE 197 39 632 A1 by a suitable arrangement of the actuating elements, so that the force is applied in a direction outside the disengagement direction, thereby lowering the risk of disengagement. However, the implementation of these gear shift assemblies is quite complex because they require at least three ball joints, which makes fabrication and maintenance time-consuming and expensive. In addition, the cable pulls attached to the actuating elements are subject to large angular excursions during gear shifting caused by the upward and downward movement of the actuating elements during gear shifting. Because cable pulls should not have an excursion of more than approximately 11°, which would otherwise decrease their efficiency, the gear box has to be very precisely adjusted to minimize the excursions of the cable pulls, which again increases cost and maintenance requirements. The required arrangement of the actuating elements disadvantageously also causes large bending and torsion torques during gear shifting, due to the tilt of the gear shift lever and the corresponding excursion of the cable pulls. This can lower the efficiency and cause premature fatigue of the material and hence shorten the service life of the gear shift assembly. The ball joint of the gear shift assembly can also easily disengage and jam when the driver of the automobile pivots the gear switch lever while the automobile is in motion.

DE 196 00 526 C2 and DE 44 26 207 C1 disclose gear shift assemblies for an automatic gear box of an automobile, whereby the gear selection lever can be moved back and forth between two different gear shift gates. The gear shift cable is implemented as a cable pull and attached to the lower free end of the gear shift lever. The cable pull is moved at the same time the gear shift lever is pivoted from the gear shift gate into the gear selection gate. This excursion of the cable pull also lowers the efficiency and shortens the service life of the cable pull and/or of the gear box due to the increased load.

It is therefore an object of the present invention to provide a gear shift assembly in which the gear shift motion is substantially decoupled from the gear selection motion, and which can be manufactured, assembled and operated more easily and more reliably.

### BRIEF SUMMARY OR THE INVENTION

The object is solved by the invention with a gear shift assembly according to the characterizing features of claim 1. Additional advantageous embodiments of the gear shift assembly of the invention according to claim 1 are recited in the dependent claims.

The gear shift assembly of the invention includes a gear shift lever which is cardanically supported by two defined fixed pivot axles. Gear shift cable pull and gear selection cable pull are disposed at separate locations, and the gear shift motion and gear selection motion are decoupled from each other. During the shifting operation, the gear shift cable pull experiences only a small angular excursion along a circle defined by a crosspiece during the pivoting motion, which can be regarded as a substantially linear motion. The crosspiece with the attached gear shift lever is offset from the gear shift axle and is pivotally supported in a housing for pivoting about the gear shift axle. The gear shift lever that is pivoted for effecting the gear shift motion causes the crosspiece to follow in the direction of the gear shift motion. The crosspiece operates the gear shift cable pull that is secured to the lower end of the crosspiece, so that the gear shift cable pull is not directly connected with the gear shift lever. The attack point of the force is almost constant due to the very small excursion of the gear shift cable pull, thereby also maintaining a constant efficiency, which tends to decrease for large angular excursions of the cable pulls, and extending the service life of the cable pull due to the uniform load.

Advantageously, the gear selection axle can be disposed in the crosspiece, and the gear shift lever can be pivotally supported on the gear selection axle, so that the two mutually decoupled pivot axles are positively guided. The driver is thereby prevented from pivoting the gear selection lever with the gear shift knob, which reduces the risk that the gear shift lever accidentally jams or the gear shift assembly is damaged. Advantageously, with this arrangement the crosspiece remains essentially at rest when the gear shift lever is pivoted about the gear selection axle, because the cable pull remains also at rest when the gear shift lever is pivoted in the direction of the gear selection motion and the angle does not change.

Advantageously, the gear shift lever can be guided in a direction of the gear shift motion in the crosspiece without clearance by a sliding block arranged on the lower free end of the gear shift lever and offset from the gear shift axle, so that a lever of this type requires only a small force to execute the gear shift motion and to cause the crosspiece to follow. The sliding block disposed at the lower free end also supports the gear shift lever without clearance and hence precisely guides the gear shift lever when the gear shift lever is pivoted in the direction of the gear selection motion. The gear shift lever slides back and forth in a recess provided in the crosspiece, following the motion of a gear shift lever.

In addition, the sliding block can include a roller which enables the gear switch lever to pivot so as to execute the gear selection motion on a path defined by the crosspiece. The crosspiece remains essentially stationary. The gear shift characteristic is determined by a shape of a gate of the crosspiece in the region of the bearing surface of the roller. The slope of the gate determines the force that has to be applied for moving to the gear shift lever against the spring force of the coil spring.

In addition, the bearing surface of the roller of the gate of the crosspiece is formed so that a limit stop prevents an unintentional engagement of the reverse gear. This can be accomplished, for example, by introducing ribs that allow shifting into that gear shift gate only by applying a greater force or by way of an optional unlocking mechanism.

Advantageously, the gear shift lever can include a gear shift finger, which is pivotally supported in a bearing of a gear selection level and operates a gear selection cable pull via the gear selection lever when the gear shift level is pivoted. The gear shift finger formed on the gear shift lever moves the upper free end of the selection lever upward or downward when the gear shift lever is pivoted. The gear selection lever can also be angled and supported at its apex so that the gear selection cable pull that is affixed to the other free end of the gear selection lever moves back and forth almost linearly as a result of the up and down motions caused by the gear shift finger. The gear shift finger is not subjected to large bending or torsion torques when the gear selection cable pull is operated, because the lever action and the multiplication achieved by the shape of the gear selection lever substantially reduces the force required to operate the gear shift lever.

Advantageously, the bearing shell supporting the gear shift finger of the gear switch lever is inserted in the gear selection lever so that is can perform small excursions for height compensation when the gear shift lever is pivoted in the direction of the gear selection motion.

Advantageously, the gear selection lever can also include additional recesses that enable the bearing shell, when shifting in an outer gear shift gate, to move in the gear selection lever according to the circular path defined by the gear shift finger of the gear shift lever.

Unlike state-of-the-art gear shift assemblies, the gear shift assembly of the invention represents a significantly simpler design that requires less maintenance, because only a single ball joint is used for support of the gear shift finger. Moreover, since two fixed axles are used that are indirectly operated by the gear shift cable pull and the gear selection cable pull, the gear shift lever moves along precisely defined paths, which reduces the risk that the gear shift knob accidentally jams, or a driver of the automobile accidentally disengages the ball joint by unintentionally pivoting the gear shift lever, or by an extreme excursion of the gear shift lever when shifting in the outermost shift gates.

### BRIEF DESCRIPTION OF THE SEVERAL VIEWS OF THE DRAWING(S)

An embodiment of the gear shift assembly according to the invention will be described in more detail hereinafter with reference to the drawing.

It is shown in:

FIG. 1 a perspective view of the gear shift assembly;

FIG. 2 a rear view of the gear shift assembly with different positions of the gear shift lever; and

FIG. 3 a side view of the gear shift assembly from the left.

### DETAILED DESCRIPTION OF THE INVENTION.

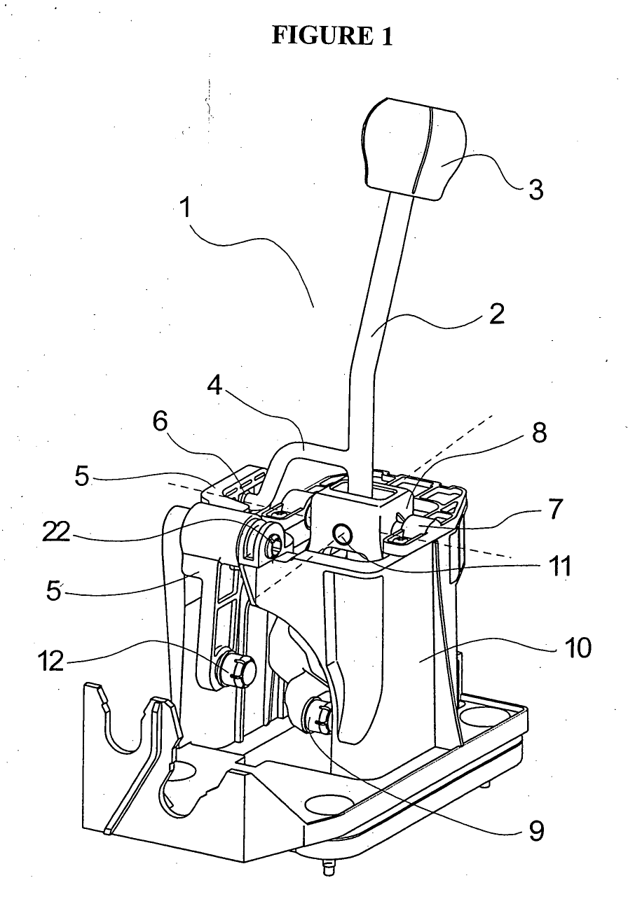

FIG. 1 shows a gear shift assembly 1 for automobiles with a gear shift lever 2. A gear shift knob 3 is screwed or pushed on the upper free end of the gear shift lever 2. A gear shift finger 4 is formed on the gear shift lever 2, which has an angled shape and is supported in a gear selection lever 5 by a ball joint 6. The gear shift lever 2 is also connected with a crosspiece 8 by a bolt connection 7. The bolt connection 7 makes it possible to pivot the gear shift lever 2 in the direction of a gear selection motion, with the depicted embodiment enabling shifting between the various gear shift gates by pivoting the gear shift lever 2 in the direction of the gear selection motion transversely to the travel direction of the automobile. For example, for automatic transmissions, two different gear shift gates can be arranged in the gear shift assembly 1, but the gear shift assembly 1 may also have three or more gear switch gates, for example in manual H-gear boxes with up to six forward gears and one reverse gear.

The crosspiece 8 is axially supported by two connecting pieces. This axial support is fixedly attached on two sides of a housing 10, thereby enabling the crosspiece to pivot in the direction of the gear shift motion. The direction of the gear shift motion in this embodiment is oriented along the travel direction of the automobile and perpendicular to the direction of the gear selection motion. In addition, an attachment point 9 for a cable pull (not shown), the gear shift cable pull, is disposed on the lower free end of the crosspiece 8.

In the depicted embodiment, the gear selection lever 5 has an angle of 90° and is supported in the housing 10 in the region of the angular bent by a bolt connection. An attachment point 12 for a gear selection cable pull is disposed on the lower free end of the gear selection lever 5.

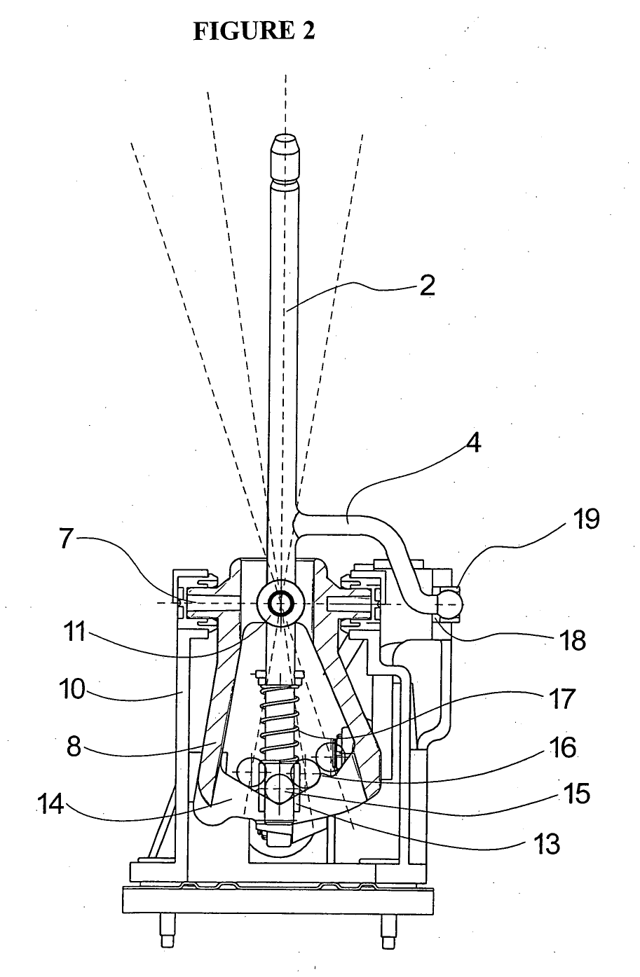

FIG. 2 shows a rear view of the embodiment of the gear shift assembly 1 according to the invention. A sliding block 13 is formed on the lower free end of the gear shift lever 2. A recess 14 is provided in the crosspiece 8, which together with the sliding block 13 arranged in the recess 14 supports the gear shift lever 2 in the crosspiece 8 without clearance. A roller 15 is attached to the sliding block 13 which rolls on a path defined by a gate 16 of the crosspiece 8. The dashed lines represent the different regions into which the gear shift lever 2 can be pivoted for shifting to the different gear shift gates when the roller 15 is in the various illustrated positions. A coil spring 17 can be arranged above the sliding block 13, which assists in returning the gear shift lever 2 to a predetermined, or preferred, gear shift gate. The shifting characteristic of the gear shift assembly can be defined flexibly by suitably shaping the gate 16 of the crosspiece 8 in the region of the bearing surface of the roller 15. The changeover from one gear shift gate to another gear shift gate can be made easier or more difficult by suitably shaping the slope of the bearing surface of the roller on the gate 16 of the crosspiece 8, because the gear shift gate can be changed only against the spring force of the coil spring 17.

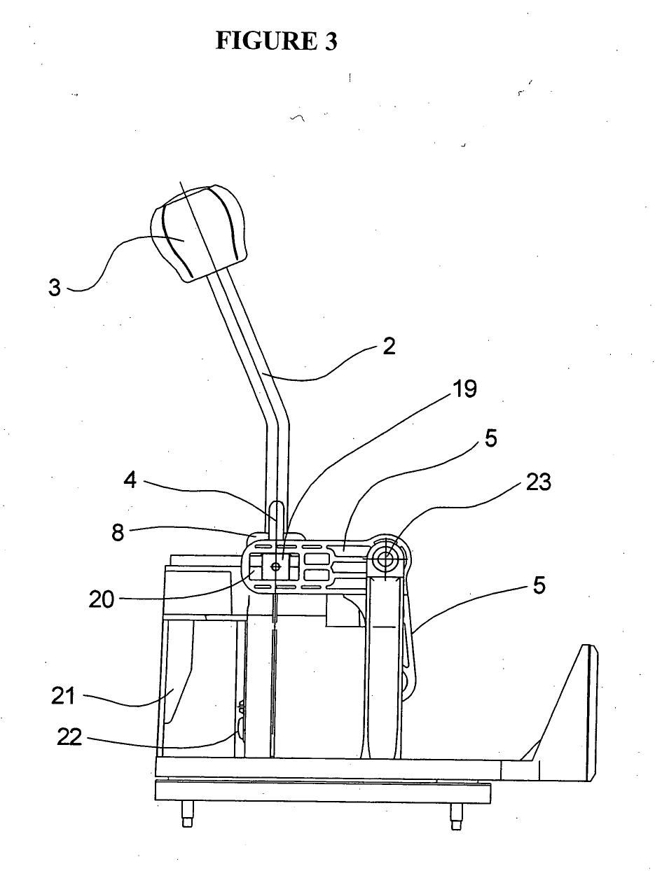

FIG. 3 shows a side view of the embodiment of the gear shift assembly 1 according to the invention. The gear selection lever 5 has a clearance 20 that allows movement of a bearing shell 19 in the gear selection lever 5 in the direction of the gear shift motion, when the gear shift finger 4 moves outside the central gear shift gate on a circular path. Moreover, a limit stop 21 and another limit stop (not shown) are disposed on the housing 9 that limit movement in the direction of the gear shift motion. An elastomer damper 22 secured on the crosspiece as well as another damper (not shown) provide a resilient recoil of the crosspiece to prevent damage when the crosspiece reaches the limit stops 21 that limit the gear shift motion.

When the gear shift lever 2 is operated in the direction of the gear shift motion, the gear shift cable (not shown) is moved by the crosspiece 1 forward or backward, depending on the gear shift operation. This initiates a gear shift in the gear box (not shown). When the gear shift lever 2 is pivoted in the direction of the gear shift motion, the gear selection lever 5 as well as the gear selection cable (not shown) remain at rest, because during this motion the gear shift finger 4 supported in the gear selection lever 5 performs only a pivoting motion in the ball joint 6.

For operating the gear selection cable pull, the gear shift lever is pivoted in the direction of the gear selection motion, i.e. perpendicular to the direction of travel, and the gear selection lever 5 is pivoted by a gear shift finger 4 which is formed on the gear shift lever 2. For example, if the gear shift lever 2 is pivoted to the right, then the upper free end of the gear selection lever 5 is pushed downward by the gear shift finger 4. This causes the gear selection lever 5 to pivot about the bolt connection 23, thereby pushing the lower free end of the gear selection lever 5 forward. The gear selection cable pull is then operated, and the corresponding change in the gear shift gates is transmitted to the gear box. Likewise, when the gear shift lever 2 is pivoted to the left, the gear shift finger pushes the gear selection lever upward, so that the lower free end of the gear selection lever 5 moves backward. When the gear shift gates are changed by pivoting the gear shift lever in the direction of the gear selection motion, the sliding block 13 slides accordingly to the right or to the left.

To enable the gear shift lever 2 to pivot into the outer positions, the ball joint 6 and/or the bearing shell 19 of the ball joint must be movably supported in the gear selection lever 5 so as to support the gear shift finger 4 in the direction of the gear selection motion. For this purpose, a motion gap 18 is provided in the gear selection lever 5 that enables movement of the bearing shell 19 when the gear shift lever 2 is pivoted in the direction of the gear selection motion. When the gear shift lever 2 is pivoted to the right, bearing shell 19 is also moved to the right in the motion gap 18 in the direction of the gear selection motion within the gear selection lever 5. Likewise, pivoting the gear shift lever 2 to the left in the direction of the gear selection motion moves the bearing shell 19 to the left in the motion gap 18 in the gear selection lever 5.

While moving in the direction of the gear selection motion, the crosspiece 8 remains at rest, so that pivoting the gear shift lever 2 in the direction of the gear selection motion does not change the angle at which the force is applied by the gear shift cable pull, which translates into a constant efficiency of the gear shift assembly 1.

If the gear shift lever is located in one of the outer gear shift gates, then a gear shift motion cannot be performed unless the ball joint 6 and/or the bearing shell 19 of the ball joint are movably supported in the gear selection lever 5 that supports the gear shift finger 4 in the direction of the gear shift motion. For this purpose, a motion window 20 is provided in the gear selection lever 5 which allows the bearing shell 19 to move when the gear shift lever 2 is pivoted in the direction of the gear shift motion. When the gear shift lever 2 is pivoted forward in the travel direction, then the bearing shell 19 also moves forward in the motion window 20 in the travel direction in the gear selection lever 5. Pivoting the gear shift lever 2 backward in the direction of the gear shift motion opposite to the travel direction likewise causes the bearing shell 19 to move backward in the motion window 20 within the gear selection lever 5.

For this embodiment, FIG. 2 shows schematically a possibility for implementing an impact stop 24, for example to protect against unintended engagement of the reverse gear. In the depicted embodiment, the gear shift lever 2 has to be pivoted fully to the left to engage the reverse gear. The impact stop 24 is implemented as a projection. A significantly greater force is required for overcoming the projection than for pivoting the gear shift lever 2 when selecting a different gear shift gate. A shift into this gear shift gate can only be performed by increasing the force (e.g. by a sudden impact) or through an optional unlocking mechanism.

### LIST OF REFERENCE CHARACTERS

1 Gear shift assembly

2 Gear shift lever

3 Gear shift knob

4 Gear shift finger

5 Gear selection lever

6 Ball joint

7 Bolt connection for gear shift axle gear shift lever

8 Crosspiece

9 Attachment gear shift cable pull

10 Housing

11 Bolt connection for gear selection axle gear shift lever

12 Attachment gear selection cable pull

13 Sliding block

14 Recess for guiding the sliding block

15 Roller

16 Gate of the crosspiece

17 Spring

18 Motion gap

19 Bearing shell

20 Motion window

21 Limit stop crosspiece

22 Elastomer damper for limit stop

23 Bolt connection gear selection lever

24 Impact stop

1. A gear shift assembly for a gear box of an automobile, comprising
a gear shift pattern that includes at least two gear shift gates arranged approximately in the longitudinal direction of the automobile;
at least one gear selection gate arranged perpendicular to the gear shift gates, with a gear shift lever supported for pivoting about two pivot axles, wherein a first pivot axle represents a gear shift axle and another pivot axle represents a gear selection axle, and wherein a gear shift motion in the direction of a gear shift gate and a gear selection motion in the direction of the gear selection gate can be performed by pivoting the gear shift lever, with the gear selection motion and gear shift motion being decoupled from each other,
wherein a crosspiece (8) with a gear shift lever (2) secured to the crosspiece with an offset from the gear shift axle is supported in a housing (9) for pivoting about the gear shift axle, and
wherein pivoting the gear shift lever (2) in the direction of the gear shift motion causes the crosspiece (8) to follow the gear shift lever (2), thereby operating the gear shift cable pull that is secured to a lower free end of the crosspiece (8).

2. The gear shift assembly according to claim 1, wherein the gear selection axle is disposed in the crosspiece (8), and the gear shift lever (2) is pivotally supported on the gear selection axle.

3. The gear shift assembly according to claim 1,
wherein the crosspiece (8) remains essentially at rest when the gear shift lever (2) is pivoted about the gear selection axle.

4. The gear shift assembly according to claim 1, wherein the gear shift lever (2) is guided in a direction of the gear shift motion in the crosspiece (8) without clearance by a sliding block (13) arranged on the lower free end of the gear shift lever (2) and offset from the gear shift axle.

5. The gear shift assembly according to claim 4, wherein the sliding block (13) includes a roller (15) which enables the gear switch lever (2) to pivot so as to execute the gear selection motion on a path defined by the crosspiece (8), and whereby the crosspiece (8) remains essentially at rest.

6. The gear shift assembly according to claim 5, wherein the gear shift characteristic is determined by a shape of a gate (16) of the crosspiece (8) in the region of the bearing surface of the roller (15).

7. The gear shift assembly according to claim 6, wherein the bearing surface of the roller (15) of the gate (16) of the crosspiece (8) is formed so that a limit stop prevents an unintentional engagement of the reverse gear.

8. The gear shift assembly according to claim 1, wherein the gear shift lever (2) includes a gear shift finger (4) which is pivotally supported in a bearing of a gear selection level (5) and operates a gear selection cable pull via the gear selection lever (5) when the gear shift level (2) is pivoted.

9. The gear shift assembly according to claim 8, wherein a bearing shell (19) supporting the gear shift finger (4) of the gear switch lever (2) in the gear selection lever (5) can perform small excursions in a motion gap (18) for height compensation when the gear shift lever (2) is pivoted in the direction of the gear selection motion.

10. The gear shift assembly according to claim 9, wherein the gear selection lever (5) includes a motion clearance window (20) which enables a motion of the bearing shell (19) in the gear selection lever (5) according to the circular path defined by the gear shift finger (4) of the gear shift lever (2) during shifting in an outer gear shift gate.
